(19) United States
(12) Patent Application Publication
(10) Pub. No.: US 2009/0150868 A1
(43) Pub. Date: Jun. 11, 2009

(54) Method and System for Capturing Movie Shots at the Time of an Automated Graphical User Interface Test Failure

(76) Inventors: Al Chakra, Apex, NC (US); Wes Hayutin, Raleigh, NC (US); Robert Kainz, Cary, NC (US); John F. Sefler, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/953,535

(22) Filed: Dec. 10, 2007

(51) Int. Cl. G06F 9/44

(52) U.S. Cl. 717/125

(57) ABSTRACT

A method of capturing movie shots at the time of an automated Graphical User Interface (GUI) test failure. When an automated GUI test application performs an action during a test of a GUI, the GUI test application adds a text description of the action to a test log and captures a screenshot image of the GUI. The GUI test application adds the screenshot image to a rolling First-In-First-Out (FIFO) queue that includes up to a most recent N screenshot images, where N is a pre-defined configurable number. If an error occurs, the GUI test application captures a final failure point screenshot image. The GUI test application adds the final screenshot image to the rolling FIFO queue and the test log. The GUI test application assembles the screenshot images from the rolling FIFO queue into a chronologically animated movie file and attaches the movie file to the test log.

### BACKGROUND OF THE INVENTION

The present invention relates in general to data processing systems and in particular to automated Graphical User Interface (GUI) test applications.

Software developers typically use application programs, such as automated GUI test frameworks, to verify the performance and functional accuracy of new GUIs. Automated GUI test applications generate a log file during each test that includes a text representation of all actions performed during the test. Log files thus enable software developers to troubleshoot GUI failures by analyzing the actions that occurred up to the point of failure (e.g., by manually recreating the failure). Conventional automated GUI test applications may also include a screenshot captured at the moment a failure occurred. However, a screenshot captured at the point of failure may not include sufficient information to enable a software developer to analyze the one or more actions that potentially caused the failure.

### SUMMARY OF AN EMBODIMENT

Disclosed are a method, system, and computer storage medium for capturing movie shots at the time of an automated Graphical User Interface (GUI) test failure. When an automated GUI test application performs an action during a test of a GUI, the GUI test application adds a text description of the action to a test log and captures a screenshot image of the GUI. The GUI test application adds the screenshot image to a rolling First-In-First-Out (FIFO) queue that includes up to a most recent N screenshot images, where N is a pre-defined configurable number. Once an error occurs, the GUI test application captures a final failure point screenshot image. The GUI test application adds the final screenshot image to the rolling FIFO queue and the test log. The GUI test application assembles the screenshot images from the rolling FIFO queue into a chronologically animated movie file and attaches the movie file to the test log.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2A illustrates a first view of an exemplary Graphical User Interface (GUI) test log, according to an embodiment of the present invention;

FIG. 2B illustrates a second view of the GUI test log of FIG. 2A, according to an embodiment of the present invention; and

FIG. 3 is a high level logical flowchart of an exemplary method of capturing movie shots at the time of an automated Graphical User Interface (GUI) test failure.

### DETAILED DESCRIPTION OF AN ILLUSTRATIVE EMBODIMENT

The present invention provides a method, system, and computer storage medium for capturing movie shots at the time of an automated Graphical User Interface (GUI) test failure.

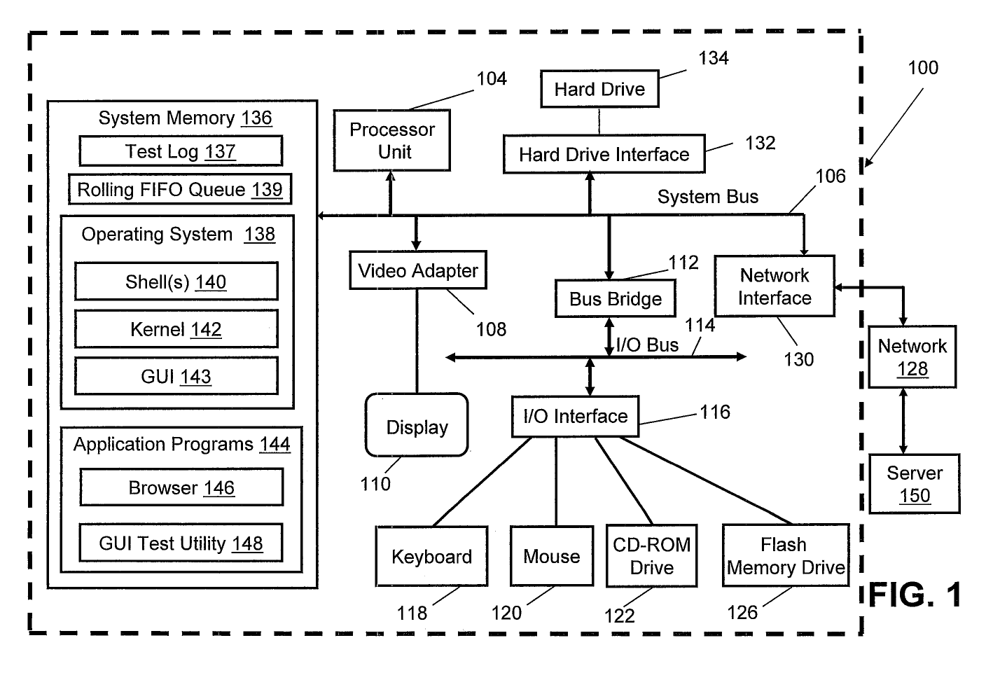

With reference now to FIG. 1, there is depicted a block diagram of an exemplary computer 100, with which the present invention may be utilized. Computer 100 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, and flash memory drive 126. The format of the ports connected to I/O interface 116 may be any known to those skilled in the art of computer architecture, including but not limited to Universal Serial Bus (USB) ports.

Computer 100 is able to communicate with server 150 via network 128 using network interface 130, which is coupled to system bus 106. Network 128 may be an external network such as the Internet, or an internal network such as a Local Area Network (LAN), an Ethernet, or a Virtual Private Network (VPN). In one embodiment, server 150 is configured similarly to computer 100.

Hard drive interface 132 is also coupled to system bus 106. Hard drive interface 132 interfaces with hard drive 134. In one embodiment, hard drive 134 populates system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Data that populates system memory 136 includes Operating System (OS) 138 and application programs 144. In one embodiment, system memory 136 also includes one or more test logs 137 and one or more rolling First-In-First-Out (FIFO) queues 139. As utilized herein, a FIFO queue refers to a queue that includes up to N screenshots of a Graphical User Interface (GUI), where N is a pre-defined positive integer that may be configured by a user of computer 100. For example, if rolling FIFO queue 139 already includes N screenshots when a new screenshot is added, the oldest screenshot is removed, such that rolling FIFO queue 139 only includes the most recent N screenshots.

In an alternate embodiment, rolling FIFO queue 139 may include up to N digital camera shots of a visual inspection point on a physical assembly line (e.g., camera shots captured at a manufacturing check point). A camera connected to computer 100 may capture one or more still photographs of the visual inspection point that may be stored in rolling FIFO queue 139 and subsequently assembled into an animated movie format viewable by a user of computer 100.

OS 138 includes shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes GUI 143 and kernel 142, which includes lower levels of functionality for OS 138. Kernel 142 provides essential services required by other parts of OS 138 and application programs 144. The services provided by kernel 142 include memory management, process and task management, disk management, and I/O device management.

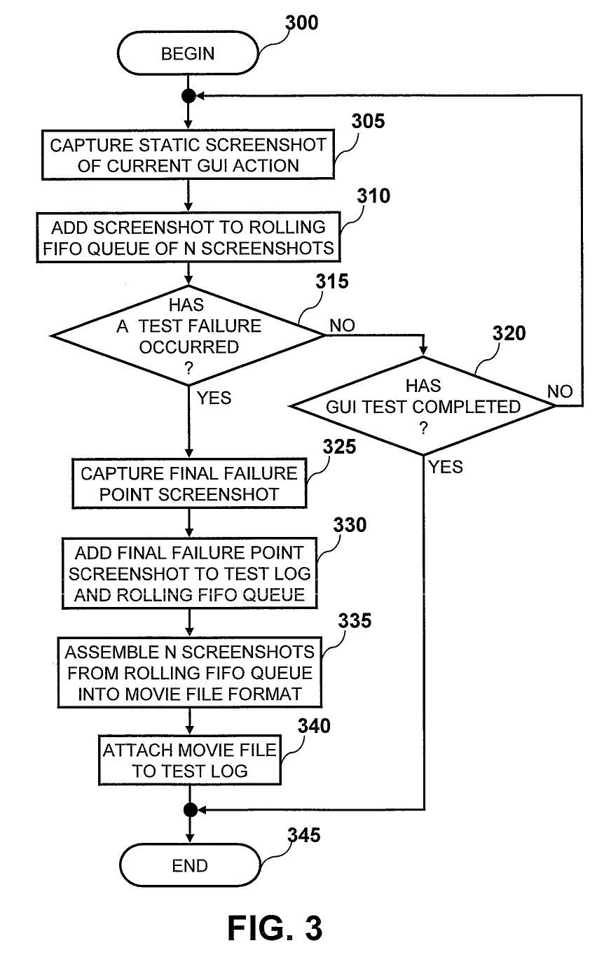

Application programs 144 include browser 146 and GUI test utility 148. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. According to the illustrative embodiment, GUI test utility 148 performs the functions illustrated in FIG. 3, which is described below. In an alternate embodiment, OS 138 may perform the functions illustrated in FIG. 3.

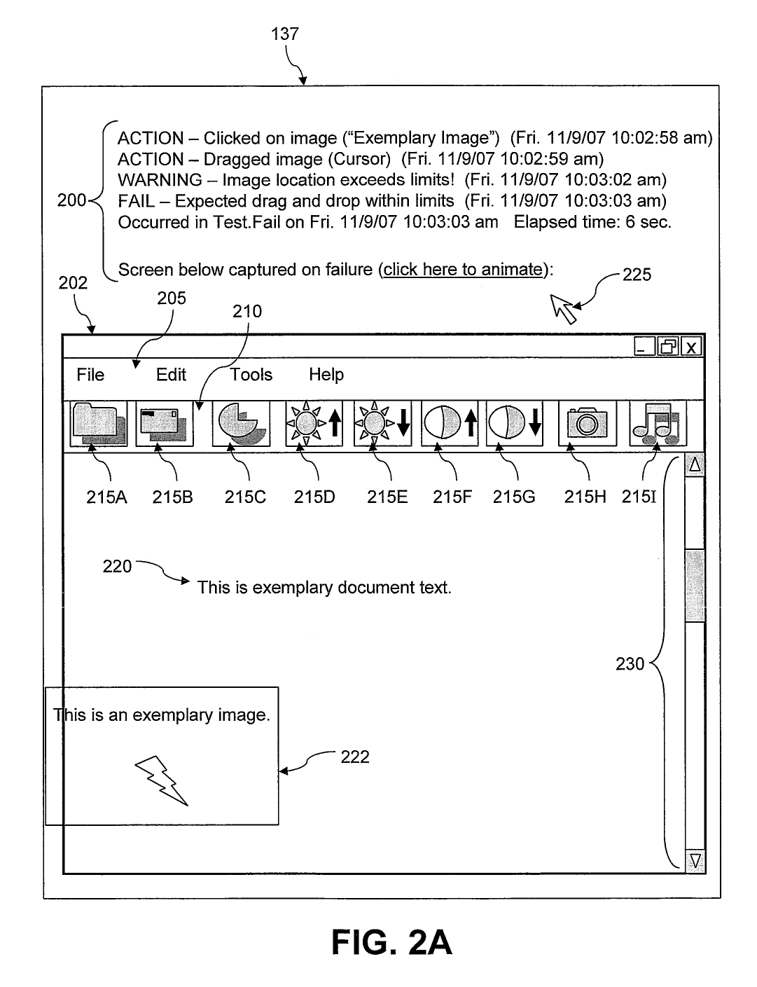

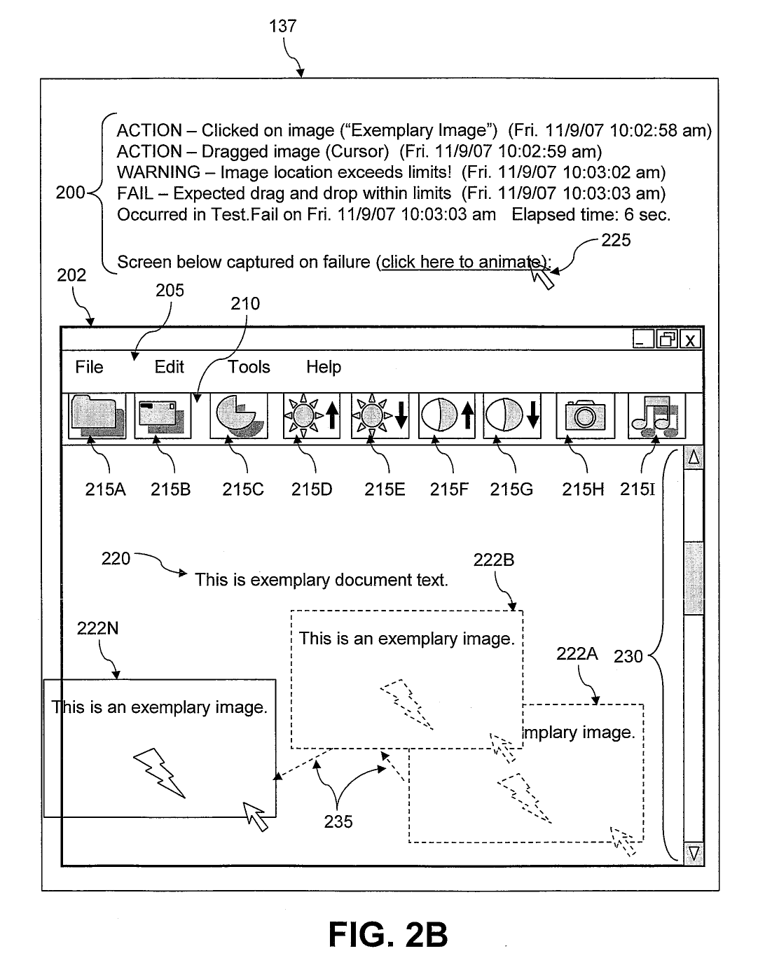

With reference now to FIG. 2A, there is depicted a first view of an exemplary GUI test log, according to an embodiment of the present invention. As shown, test log 137 (FIG. 1) includes one or more lines of test action text 200, each of which corresponds to an action performed by GUI test utility 148 (FIG. 1) during an automated GUI test. Test action text 200 may also include one or more warnings and/or error messages provided by GUI test utility 148 in response to errors that occurred during a test of GUI window 202. Test log 137 also includes a screenshot of GUI window 202. The screenshot of GUI window 202 in test log 137 corresponds to a final screenshot captured at a point of failure during a test of GUI window 202. Test action text 200 may also include a clickable text link (e.g., “click here to animate”) and/or a clickable movie icon that corresponds to a movie file including up to N sequential screenshots (i.e., chronological animation) of actions performed during a test of GUI window 202, where N is a pre-defined value that may be configured by a user of computer 100 (FIG. 1). A movie file may be embedded within and/or attached to test log 137. If a user positions cursor 225 in proximity to the clickable text link and/or the clickable movie icon and clicks on the link and/or icon, GUI test utility 148 may animate the screenshot of GUI test window 202 (i.e., play a movie of GUI test actions) at a playback speed that is adjustable by the user, as illustrated in FIG. 2B, which is discussed below.

In one embodiment, GUI window 202 may include window control bar 205, and toolbar 210. Window control bar 205 may include one or more pull down menus (e.g., a “file” menu). Similarly, toolbar 210 may include multiple toolbar icons 215A-I, including, but not limited to, open file icon 215A, email file icon 215B, insert chart icon 215C, increase brightness icon 215D, decrease brightness icon 215E, increase contrast icon 215F, decrease contrast icon 215G, insert picture icon 215H, and insert audio icon 215I.

According to the illustrative embodiment, GUI window 202 may include data, such as one or more lines of document text 220 and/or one or more images 222. An automated test utility, such as GUI test utility 148, and/or a user of GUI window 202 may view multiple pages of document text 220 and/or images 222 in GUI window 202 by adjusting scroll bar 230. GUI test utility 148 may manipulate toolbar icons 215A-215I, document text 220, and/or images 222 by simulating input from keyboard 118 and/or mouse 120 (i.e., cursor 225) during an automated test of GUI window 202. GUI test utility 148 includes each action performed during a test of GUI window 202 in test action text 200. A method of performing an automated test of GUI window 202 is illustrated in FIG. 3, which is described below.

With reference now to FIG. 2B, there is depicted a second view of the exemplary GUI test log of FIG. 2A, according to an embodiment of the present invention. As shown, a user of test log 137 (FIG. 1) has positioned cursor 225 in proximity to a clickable text link included in test action test 200, and the user has clicked on (i.e., activated) the link. GUI test utility 148 (FIG. 1) is thus playing a movie that includes the most recent N screenshots captured during a test of GUI window 202. A method of creating a movie of the most recent N screenshots is illustrated in FIG. 3, which is described below.

According to the illustrative embodiment, the movie (i.e., animation) of the most recent N actions performed during the test of GUI window 202 includes GUI test utility 148 “dragging and dropping” (i.e., moving) image 222. As shown, image 222 was dragged from location 222A to location 222B and subsequently to location 222N, as indicated by motion lines 235, which are provided solely for reference. When GUI test utility 148 moved image 222 to location 222N (i.e., the last location), an error occurred since location 222N is outside the graphical display area of GUI window 202. A movie may include other actions leading up to a different error (e.g., clicking on one or more of toolbar icons 215A-215N, clicking on window control bar 205, adjusting scroll bar 230, and/or manipulating document text 220). In one embodiment, a user of computer 100 may adjust a playback speed, stop, pause, and/or rewind the movie. In an alternate embodiment, GUI test utility 148 may use another one of application programs 144 (FIG. 1) to play a movie including the most recent N screenshots in a different window separate from test log 137 (e.g., in a movie viewing application). In another embodiment, a camera connected to computer 100 may capture one or more still photographs of a visual inspection point of a physical assembly line that may be stored in rolling FIFO queue 139 and subsequently assembled into an animated movie format.

Turning now to FIG. 3, there is illustrated a high level logical flowchart of an exemplary method of capturing movie shots at the time of an automated GUI test failure, according to an embodiment of the invention. The process begins at block 300 in response to a user of computer 100 (FIG. 1) using an automated test utility, such as GUI test utility 148 (FIG. 1), to test a GUI, such as GUI window 202 (FIGS. 2A-2B). GUI test utility 148 captures a static screenshot (i.e., a “still image”) of GUI window 202 after performing an action during the test, and GUI test utility adds the action to test action text 200 (FIGS. 2A-2B) within test log 137 (FIG. 1), as depicted in block 305. GUI test utility 148 adds the screenshot to rolling FIFO queue 139 (FIG. 1), as shown in block 310. Rolling FIFO queue 139 includes up to the most recent N screenshots captured during the test. If rolling FIFO queue 139 is full (i.e., already includes N screenshots) when a new screenshot is captured, the oldest screenshot is removed from the queue and the new screenshot is added to the queue.

At block 315, GUI test utility 148 determines whether or not a test failure has occurred (i.e., whether or not the most recent action performed during the test resulted in an error within GUI window 202). If an error has not occurred, GUI test utility 148 determines whether or not the test has been completed (i.e., whether or not GUI window 202 has passed the test), as depicted in block 320. If the test is not complete, the process returns to block 305, and GUI test utility 148 continues to capture screenshots of test actions and update rolling queue 139 and test log 137. If the test is complete, the process terminates at block 345.

If an error has occurred, GUI test utility 148 captures a final failure point screenshot (i.e., a screenshot of the moment of failure), as depicted in block 325. GUI test utility 148 adds the final failure point screenshot to rolling FIFO queue 139 and includes an image of the final failure point screenshot within test log 137, as shown in block 330.

According to the illustrative embodiment, GUI test utility 148 assembles the most recent N screenshots (i.e., the contents of rolling FIFO queue 139) sequentially into a chronological movie file format, as depicted in block 335. In one embodiment, GUI test utility 148 may assemble the most recent N screenshots into a container format, such as “.mov” or “.mpeg”. GUI test utility 148 attaches and/or embeds the assembled movie file in test log 137, as shown in block 340, and the process terminates at block 345. GUI test utility 148 thus conserves memory by efficiently storing separate screenshots within rolling FIFO queue 139 and assembling the screenshots into a movie when a test failure occurs, rather than recording a movie file during the test, which would otherwise consume a large amount of memory.

The present invention thus provides a method of efficiently capturing movie shots at the time of an automated GUI test failure. When an automated GUI test application, such as GUI test utility 148 (FIG. 1), performs an action during a test of a GUI, such as GUI window 202 (FIGS. 2A-2B), the GUI test application adds a text description of the action, such as test action text 200 (FIGS. 2A-2B), to test log 137 (FIG. 1), and captures a screenshot image of the GUI. The GUI test application adds the screenshot image to rolling FIFO queue 139 (FIG. 1) that includes up to a most recent N screenshot images, where N is a pre-defined configurable number. If an error occurs, the GUI test application captures a final failure point screenshot image. The GUI test application adds the final screenshot image to rolling FIFO queue 139 and test log 137. The GUI test application assembles the screenshot images from rolling FIFO queue 139 into a chronologically animated movie file and attaches the movie file to test log 137.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
in response to an action being performed by an automated Graphical User Interface (GUI) test application during a test of a GUI:
adding a text description of said action to a test log;
capturing a screenshot image of said GUI; and
adding said screenshot image to a rolling First-In-First-Out (FIFO) queue that includes up to a most recent N screenshot images, wherein N is a pre-defined configurable number; and
in response to a determination that an error has occurred during said test:
capturing a final failure point screenshot image;
adding said final failure point screenshot image to said rolling FIFO queue;
including said final failure point screenshot image in said test log;
assembling said most recent N screenshot images from said rolling FIFO queue into a chronologically animated movie file; and
attaching said movie file to said test log.

2. The method of claim 1, further comprising embedding said movie file in said test log, wherein said test log is included in an automated error reporting system, and wherein said automated error reporting system includes at least one of an error reporting database and an electronic mail system.

3. The method of claim 1, further comprising embedding said test log in said movie file.

4. A computer system comprising:
a processor;
a system memory coupled to said processor; and
an application program within said system memory that provides the functions of:
in response to an action being performed by an automated Graphical User Interface (GUI) test application during a test of a GUI:
adding a text description of said action to a test log within said system memory;
capturing a screenshot image of said GUI; and
adding said screenshot image to a rolling First-In-First-Out (FIFO) queue within said system memory that includes up to a most recent N screenshot images, wherein N is a pre-defined configurable number; and
in response to a determination that an error has occurred during said test:
capturing a final failure point screenshot image;
adding said final failure point screenshot image to said rolling FIFO queue;
including said final failure point screenshot image in said test log;
assembling said most recent N screenshot images from said rolling FIFO queue into a chronologically animated movie file; and
attaching said movie file to said test log.

5. The computer system of claim 4, further comprising means for embedding said movie file in said test log, wherein said test log is included in an automated error reporting system, and wherein said automated error reporting system includes at least one of an error reporting database and an electronic mail system.

6. A computer storage medium encoded with a computer program that, when executed, performs the steps of:
in response to an action being performed by an automated Graphical User Interface (GUI) test application during a test of a GUI:
adding a text description of said action to a test log;
capturing a screenshot image of said GUI; and
adding said screenshot image to a rolling First-In-First-Out (FIFO) queue that includes up to a most recent N screenshot images, wherein N is a pre-defined configurable number; and
in response to a determination that an error has occurred during said test:
capturing a final failure point screenshot image;
adding said final failure point screenshot image to said rolling FIFO queue;
including said final failure point screenshot image in said test log;
assembling said most recent N screenshot images from said rolling FIFO queue into a chronologically animated movie file; and
attaching said movie file to said test log.
